(19) United States
(12) Patent Application Publication
(10) Pub. No.: US 2015/0260384 A1
(43) Pub. Date: Sep. 17, 2015

(54) FLUORESCENT LAMP FIXTURE WITH LEDS

(71) Applicant: ELB ELECTRONICS, INC., Arcadia, CA (US)

(72) Inventor: Steven Purdy, Johns Creek, GA (US)

(21) Appl. No.: 14/644,111

(22) Filed: Mar. 10, 2015

Related U.S. Application Data
(60) Provisional application No. 61/951,453, filed on Mar. 11, 2014.

(51) Int. Cl. F21V 23/00; H05B 33/08; F21V 25/10; F21K 99/00; F21V 23/06

(52) U.S. Cl. CPC F21V 23/009; F21K 9/175; F21V 23/06; F21V 25/10; H05B 33/0845; H05B 33/0815; F21Y 2103/003

(57) ABSTRACT

A retrofit LED lamp that looks identical to a fluorescent lamp that utilize the ballast already in the fluorescent lamp fixture. The LED lamp has a housing, one or more than one LED, pins connected to the housing that mate with the tombstones of a fluorescent lamp fixture, and control circuitry to duplicate standard fluorescent lamp operations with existing AC ballast and emulate the filament winding resistance of a conventional fluorescent lamp. Optionally, the retrofit LED lamp has additional electrical elements that can be added for control functions, such as the ability to dim the retrofit LED lamp.

### CROSS-REFERENCE TO RELATED APPLICATIONS

This Application claims the benefit under 35 U.S.C. §119(e) of U.S. Provisional Patent Application Ser. No. 61/951,453, filed on Mar. 11, 2014, the contents of which are incorporated herein by reference in their entirety.

### FIELD OF THE INVENTION

This invention relates to fluorescent light fixtures in commercial and residential environments, and more particularly to an LED lamp that looks identical to a fluorescent lamp with the pins to mate with the tombstones that use the ballast already in the fixture.

### BACKGROUND

Light emitting diodes (LEDs) have been used for a long time in various applications, such as indicators. Originally, LEDs came in various colors, such as red, green, yellow, and blue. LEDs were designed to be viewed directly and to indicate the condition of a product or an alert. Recently, laser LEDs and white LEDs have been created. The colored LEDs had a typical forward voltage of 1.5V and needed 20 milliamps (mA) to 30 mA to operate. The white LEDs had a greater lumen output, and are used in backlighting electronics, like computer displays, televisions, electronics devices such as medical devices, smart phones, e-readers, and tablet devices, to name a few. White LEDs can now function as an efficient primary lighting source. These primary lighting white LEDs have a greater forward voltage drops of 3V or 6V, and operating currents of 50 mA to 350 mA. Battery operated flashlights were the first products for these new high lumen output LEDs.

Technically, LEDs are diodes where current flows in only one direction, anode to cathode. A lighting industry developed around these devices with the intention to replace conventional lighting solutions, i.e. incandescent, fluorescent, and high-intensity discharge (HID) such as mercury vapor, metal halide, ceramic discharge metal-halide, sodium-vapor, and xenon short-arc lamps, and halogen lighting. FIG. 1 shows a prior art circuit to drive an LED which comprises a DC voltage source 102 with a voltage higher than the forward voltage drop of the LED 106. Typically, a current limiting element, in this case a resistor 104, is needed between the voltage source 102 and LED 106 to limit the current for low power applications. However, this circuitry creates inefficiency due to the power loss in the resistor 104.

FIG. 2 is a prior art diagram of a circuit that is used for custom fixtures in commercial and residential lighting applications. A DC driver 202 provides a DC voltage, usually a low voltage, and a means to limit the current, such as, for example, a DC-DC converter set, to provide constant current.

Currently, there is a large base of commercial and residential buildings using fluorescent lamp fixtures with ballast for light. Most of the fixtures support a number of fluorescent lamps also known as fluorescent bulbs. Fixtures with two and three fluorescent bulbs are common. There is also a large base of one and four lamp fixtures as well. The fluorescent bulbs are usually linear tubes with mercury and gas in side. Each end of the fluorescent bulb has two pins which are connected to a filament between them resulting in a pair of pins and filament at each end of the bulb. These lamps with two pins at each side are referred to as bipin lamps. There is another type of linear lamp which has only a single pin at each end and a filament emitter. Typical lamp lengths are 2 foot, 3 foot, 4 foot and 8 foot although other sizes are available for special applications.

The ballast that drives these lamps comes in two categories either magnetic or electronic. Each of these two categories is divided into three types: instant start, programmed/rapid start, or dimming. Instant start can drive bipin or single pin lamps. programmed/rapid start and dimming types require filaments at each end for pre-heating.

Instant start ballasts 302, shown in FIG. 3, apply a large AC voltage between the ends of the lamp 304 when creating a plasma inside the lamps. This voltage can be 50/60 Hz for a magnetic ballast or 40-60 kHz for an electronic ballast. This high voltage can approach 600 VAC across each lamp 304 before the lamp 304 is struck (plasma formed). Initially, the impedance across the end to end of a lamp 304 that is not lit is essentially open. The high voltage from the ballast 302 ionizes the gases and mercury within the lamp 304, such that a plasma forms in the lamp 304 between the ends. This plasma has impedance which varies with the current that flows through the lamp 304 and the length of the lamp 304. With the instant start ballast the two filament pins are shorted at each end of the lamp 304 and the filament winding emits electrons into the plasma to sustain it. Current flows in both directions in response to the direction of the applied AC voltage.

The purpose of the ballast 302, besides providing this high AC voltage from the 120 VAC/277 VAC mains, also limits the current into the lamp 304. The plasma in the fluorescent lamp 304 has a negative impedance, which means as the current increases in the lamp 304 the voltage across that lamp 304 drops. This is opposite of a standard positive impedance like a resistor. As the current in a resistor increases, the voltage drop goes increases. The ballast 302 provides a positive impedance in series with the negative impedance of the lamp 304. The series total of the ballast 302 impedance and lamp 304 impedance must be positive to limit current into the lamp 304. The impedance of the ballast 302 is chosen to limit the current in the lamp 304 to its nominal value.

The programmed start/rapid start ballast 402, shown in FIG. 4, also applies high voltage across each end of the ballast 402, but adds 3.5 VAC across each of the filament windings to heat the filaments 404 and 406. This improves the emission of electrons from the filaments 404 and 406 and less voltage is needed to strike a plasma between the ends of the lamp 408. Typical strike voltage for programmed start/rapid start ballast 402 is about 350 VAC.

Because of the large amount of electricity used in current fluorescent lamps, and the push toward more energy efficient lighting, it would be a great cost savings to have an LED lamp that could be a drop in replacement for fluorescent lamps. However, there are no current applications where LEDs can be used in the existing fixtures using the existing ballast. Therefore, there is a need for an LED lamp that looks identical to a fluorescent lamp with the pins to mate with the tombstones that use the ballast already in the fixture.

### BRIEF DESCRIPTION OF THE DRAWINGS

These and other features, aspects and advantages of the present invention will become better understood with regard to the following description, appended claims, and accompanying figures where:

FIG. 1 is a prior art circuit diagram for an LED;

FIG. 2 is a prior art circuit diagram of a DC driver for an LED;

FIG. 3 is a prior art block diagram of an instant start ballast;

FIG. 4 is a prior art block diagram of a rapid/programmed start ballast;

FIG. 5 is a schematic diagram of an LED lamp that looks identical to a fluorescent lamp with the pins to mate with the tombstones and utilize the ballast already in the fixture, according to an embodiment of the invention;

FIG. 6 is a schematic diagram of an LED lamp according to another embodiment of the invention;

FIG. 7 is a schematic diagram of an LED lamp according to another embodiment of the invention;

FIG. 8 is a schematic diagram of an LED lamp according to another embodiment of the invention;

FIG. 9 is a schematic diagram of an LED lamp according to another embodiment of the invention;

FIG. 10 is a schematic diagram of an LED lamp according to another embodiment of the invention;

FIG. 11 is a schematic diagram of an LED lamp according to another embodiment of the invention;

FIG. 12 is a schematic diagram of an LED lamp according to another embodiment of the invention;

FIG. 13 is a schematic diagram of an LED lamp according to another embodiment of the invention; and

FIG. 14 is a schematic diagram of an LED lamp according to another embodiment of the invention.

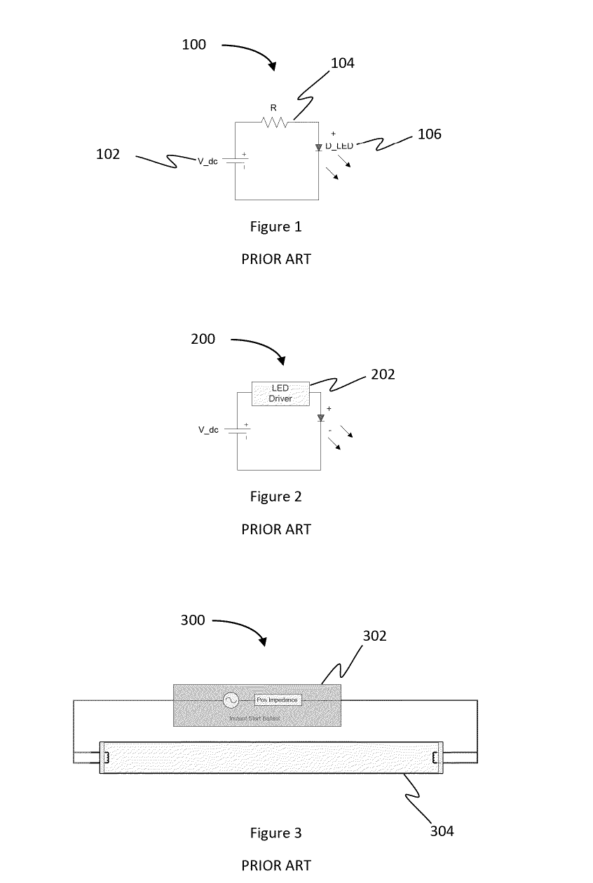

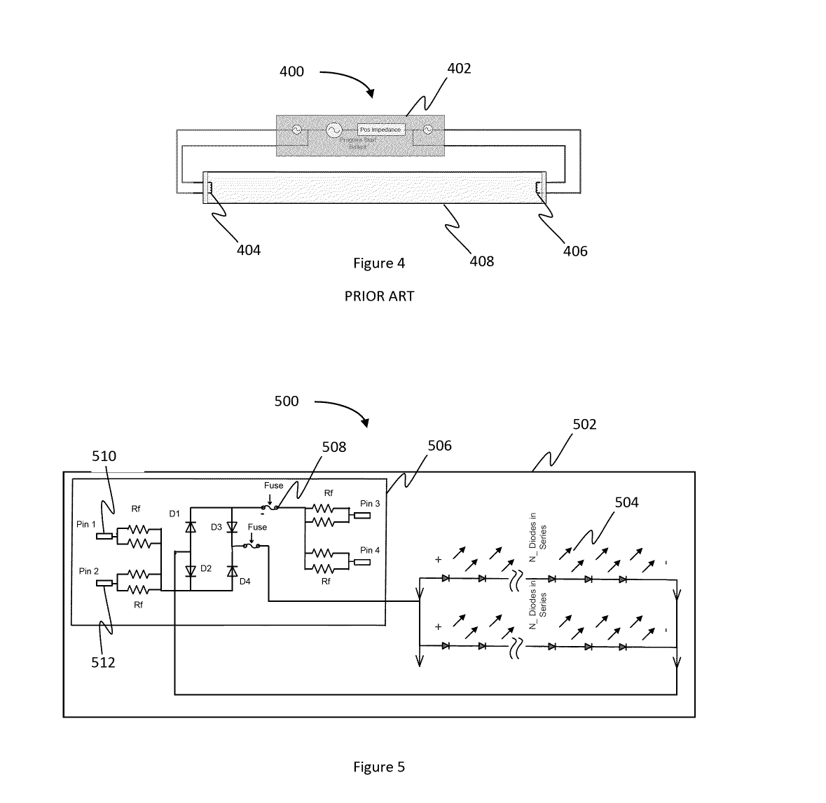

### SUMMARY

The present invention overcomes the limitations of the prior art by providing an LED lamp that looks identical to a fluorescent lamp utilizing the existing AC ballast. The LED lamp has a housing, one or more than one LED, pins that mate with the tombstones of a fluorescent lamp fixture and control circuitry to duplicate standard fluorescent lamp operations. The housing is substantially similar to the housing of a typical fluorescent lamp. The LEDs can be connected in series until the voltage drop equals that of a typical fluorescent lamp that it is replacing. The LEDs can also be connected in parallel to limit the current in a similar fashion. The control circuitry has a plurality or rectifying diodes and resistors to rectify the AC voltage from the ballast of the fluorescent lamp fixture. The resistors simulate the filament resistance of the conventional fluorescent lamp. The housing also has a fuse for protection in the event of failed components. The pins at each end of the LED lamp are shorted together if the ballast in the fixture is in an instant start ballast.

Additional electrical elements can be used to provide additional control of the LED lamp. The electrical element can be in series with the LEDs to increase the voltage of the lamp to equal that of the fluorescent lamp. The electrical elements can also be in parallel with the one or more than one LED to increase the current of the lamp. The electrical elements can be a passive component, like a capacitor, an inductor or both a capacitor and an inductor. The capacitor and the inductor are 90 degrees out of phase with the voltage. The electrical elements can be active components. The electrical element can be a dimming control that can adjust the intensity of the light coming from the one or more than one LED. The LED lamp also can have a power supply to provide power for the control functions. The electrical element can be a magnetic amplifier to control the phase of the current wave form and the light level. The electrical element can also be a capacitor in parallel across the LEDs to increase the conduction angle. The electrical element cam also be an inductor in parallel across the LEDs to increase the conduction angle. 21. The LED lamp of claim 15, where the one or more than one electrical element is a boost converter to add voltage when the wave form is below the breakdown of the one or more than one LED. The electrical element can also be a buck converter to control the light level.

### DETAILED DESCRIPTION

The present invention overcomes the limitations of the prior art by providing an LED lamp that looks identical to a fluorescent lamp with the pins to mate with the tombstones and utilize the ballast already in the fixture. Although the present invention is described using fluorescent light fixtures in commercial and residential environments, the system can be adapted to other fixtures that use similar ballasts, as will be understood by those with skill in the art with reference to this disclosure.

The system described comprises a retrofit lamp for an existing light fixture comprising one or more than one LED in a housing, and pins to electrically connect the one or more than one LED to an existing ballast, wherein the lamp emulates a conventional fluorescent lamp, such that the retrofit lamp can be used with existing ballasts.

Because LED lamps are more efficient than Fluorescent lamps, there is an incentive to replace the fluorescent lamp for energy savings. One possible solution is to replace the fixture with a DC LED driver and a unique configuration of LED amps with a polarity on the lamps so the lamps can be inserted in the proper direction DC direction. Another possibility is to use the existing fixture and replace the ballast with a DC driver for LEDS. However, the LED lamps would need to be polarized so the positive side of the lamp matches with the positive side of the driver. This would mean replacing the tombstones in the fixture with a polarized version so the lamp can't be place backwards. Tombstones are the plastic connectors in the fixture that the lamp pins plug in to provide power to the lamps.

The better solution disclosed herein, provides an LED lamp that looks identical to a fluorescent lamp with the same pins that mate with the tombstones and utilize the ballast already in the fixture. This invention covers the devices and circuits used in side an LED lamp to duplicate standard fluorescent lamp operations with existing AC ballast. The LED Lamp needs to duplicate the filament winding resistance since most instant start and rapid/program start ballast sense the filament resistance. For example, typical T8 linear fluorescent lamps have 11 Ohms of resistance. Other lamps have other values. Typical fluorescent lamps also have negative impedance after the plasma is formed. The voltage across the lamp is clamped to a value as a function of the lamp current. Large changes in the lamp current cause a small change in the clamp voltage. A typical lamp voltage for a 4 foot T8 32 W lamp is 140V for 185 ma lamp current.

The power used by a fluorescent to provide light is 140V×185 ma for a T8 lamp operating with a high frequency ballast. LEDs are twice as efficient as fluorescent lamps which would mean either the lamp voltage or the lamp current needs to be cut in half for have the power for the same light. In this invention electrical elements can be place in series with the one or more than one LED to increase the voltage of the lamp to equal that of the fluorescent lamp. Alternatively, electrical elements can be placed in parallel with the one or more than one LED to increase the current of the lamp. These elements must be designed to increase the current or the voltage, but not dissipate additional power. An inductor or a capacitor can be used that have current 90 degrees out of phase with the voltage. It is well known that the power of an electrical element is P=V×I×Cos φ where φ is the angle between the voltage and current. Passive components as well as switching circuits can be made to emulate the current thru the circuit to be out of phase with the voltage across it.

The retrofit lamp can comprise one or more than one LED in a housing, and control circuitry within the housing to control operation of the LEDs. The retrofit lamp would emulate the filament winding resistance of a conventional fluorescent lamp, such that the retrofit lamp can be used with existing ballasts.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems according to various embodiments disclosed. It should also be noted that, in some alternative implementations, the functions noted in the blocks may occur out of the order noted in the figures. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

In the following description, certain terminology is used to describe certain features of one or more embodiments of the invention.

The term “tombstones” refers to the plastic connectors in a fluorescent lamp fixture that the lamp pins plug in to provide power to the lamps.

Various embodiments provide an LED lamp that looks identical to a fluorescent lamp with the pins to mate with the tombstones and utilize the ballast already in the fixture. The device and circuits will now be disclosed in detail.

Referring now to FIG. 5, there is shown a schematic diagram of an LED lamp 500 that looks identical to a fluorescent lamp with the pins to mate with the tombstones and utilize the ballast already in the fixture, according to an embodiment of the invention.

The lamp housing 502 comprises one or more than one LED 504 within the housing 502 and additional circuitry 506 that provides electrical compatibility with current fluorescent lamp fixtures.

The one or more than one the LED 504 is connected in series until the voltage drop equals that of a typical fluorescent lamp. The housing 502 is substantially similar to the housing of a typical fluorescent lamp, such as, for example a standard T8 fluorescent lamp. However, as can be appreciated, the housing 502 can be configured in many different ways and is not limited to that of a conventional fluorescent lamp.

The voltage across the T8 fluorescent lamp is proportional to the length of the lamp. In the standard T8 lamp the voltage is about 140 V and the voltage in a 2 foot fluorescent lamp is about 70V. If the one or more than one LED has an operating forward voltage of 3 V, then approximately 23 LEDs in series would be needed to emulate the voltage drop of a 2 foot lamp.

Current LEDs have a maximum operating current of approximately 150 mA. To emulate the current in a fluorescent lamp, the housing 502 further comprise several series strings of LEDs placed in parallel to limit the current in each string. The lamp housing 502 further comprises rectifying diodes D1, D2, D3 and D4, and a plurality of resistors Rf. The rectifying diodes D1, D2, D3 and D4 rectify the ballast AC voltage. The plurality of resistors Rf are used to simulate the filament resistances of a conventional fluorescent lamp. The lamp housing 502 can further comprise one or more than one fuse 508 that can be used for added protection, in the event of failed components. If the LED lamp 500 is used in an instant start ballast, the pins 510 and 512 at each end of the LED lamp 500 are shorted together. If the LED lamp 500 is used on a ballast, the current through the one or more than one LED 502 is limited by the ballast.

As the current in the LED lamp 500 is changed by a dimming ballast, the light level will also vary. If the installed ballast is an instant start or programmed start ballast, dimming is not possible unless the ballast type is changed. Various circuits, described below, can be added to the LED lamp 500 to convert the LED lamp 500 into a dimming lamp when used on an instant start or programmed start ballast. Typical lighting controls known in the art can be added to the lamp to control light output, such as, for example, RF controls, 0-10V dimming, or digital controls can be used as a lighting control system.

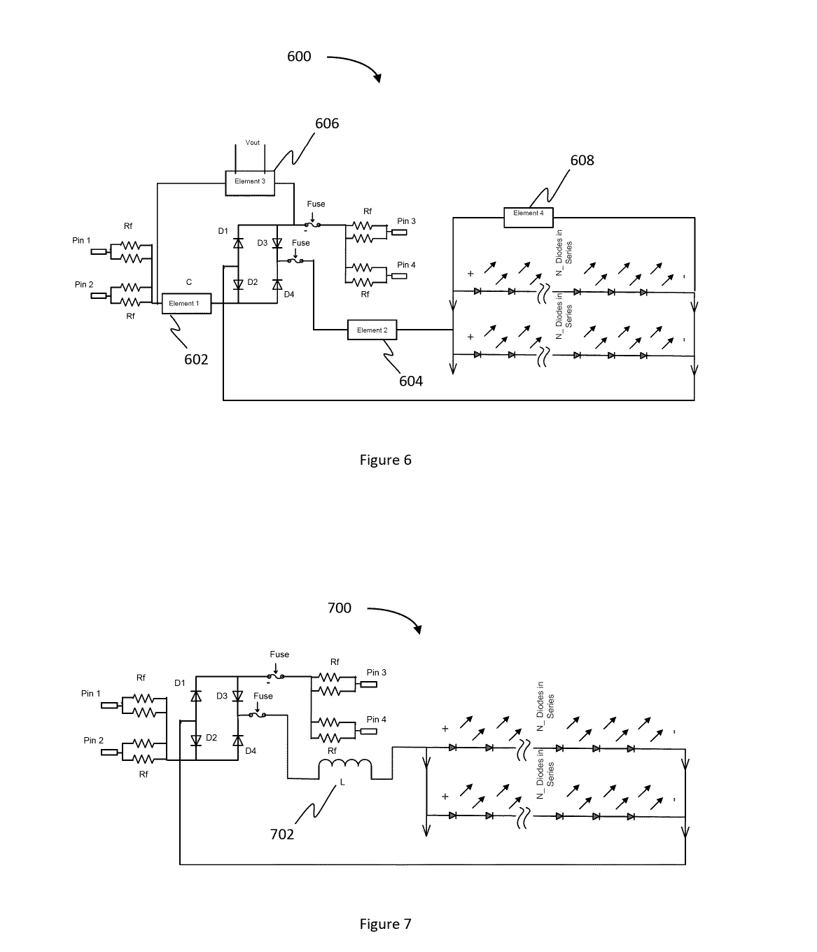

Referring now to FIG. 6, there is shown a schematic diagram of an LED lamp 600 according to another embodiment of the invention. As can be seen, elements 602, 604, 606 and 608 have been added to provide additional control for the LED lamp 600. The elements 602, 604, 606 and 608 can be replaced with circuitry to perform add to the features of the basic lamp or improve the efficiency of the lamp. Passive or active components can replace any of the elements 602, 604, 606 and 608 shown. For example, if element 3, 506 is replaced with an isolated power supply deriving power from the lamp, voltage is available for the control electronics. Various versions of the elements 602, 604, 606 and 608 will be discussed below.

Referring now to FIG. 7, there is shown a schematic diagram of an LED lamp 700 according to another embodiment of the invention. As can be seen, this embodiment of the LED lamp 700 uses an appropriately sized inductor 702 to replace element 2, 604 and provides additional current limiting to the one or more than one LED 504. Additionally, the inductor 702 also provides impedance matching to the ballast. Also, the capacitor 702 also provides impedance matching to the ballast use in the light fixture, either magnetic or electronic.

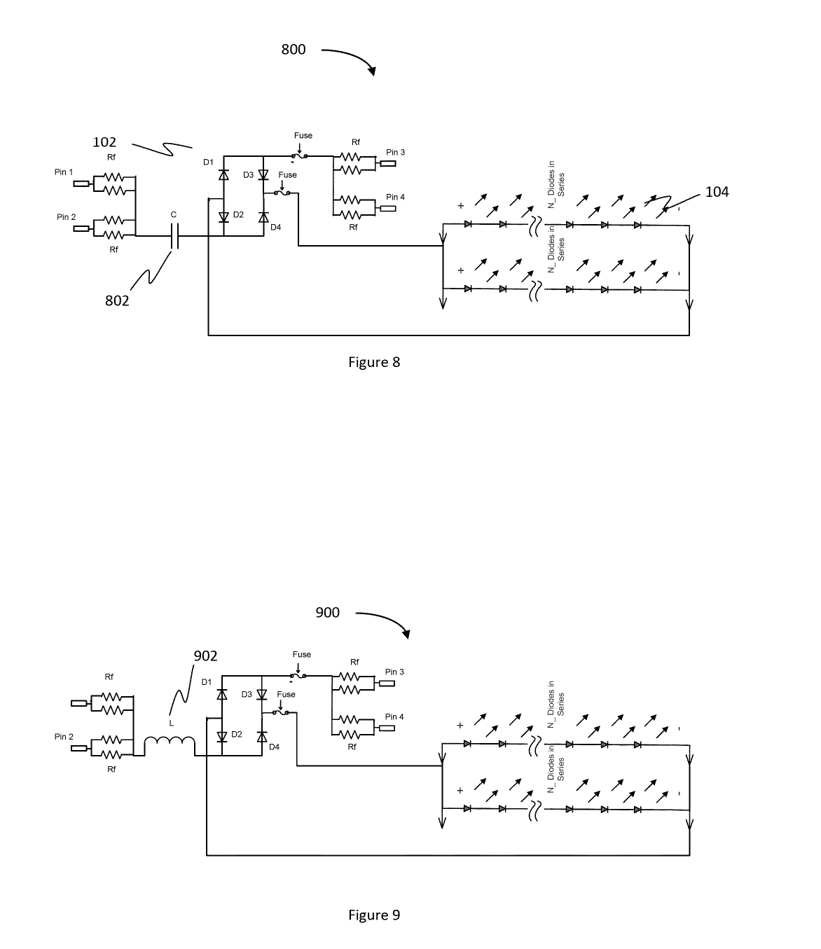

Referring now to FIG. 8, there is shown a schematic diagram of an LED lamp 800 according to another embodiment of the invention. In this version of the LED Lamp 600, a capacitor is used to replace element 1, 602. An appropriately sized capacitor 802 is used to limit the current to the one or more than one LED 504. Also, the capacitor 802 improves the power factor of the LED lamp 600.

Referring now to FIG. 9, there is shown a schematic diagram of an LED lamp 900 according to another embodiment of the invention. The LED lamp 900 uses an inductor 902 to correct the power factor of the LED lamp 600 as well as the matching impedance to the ballast.

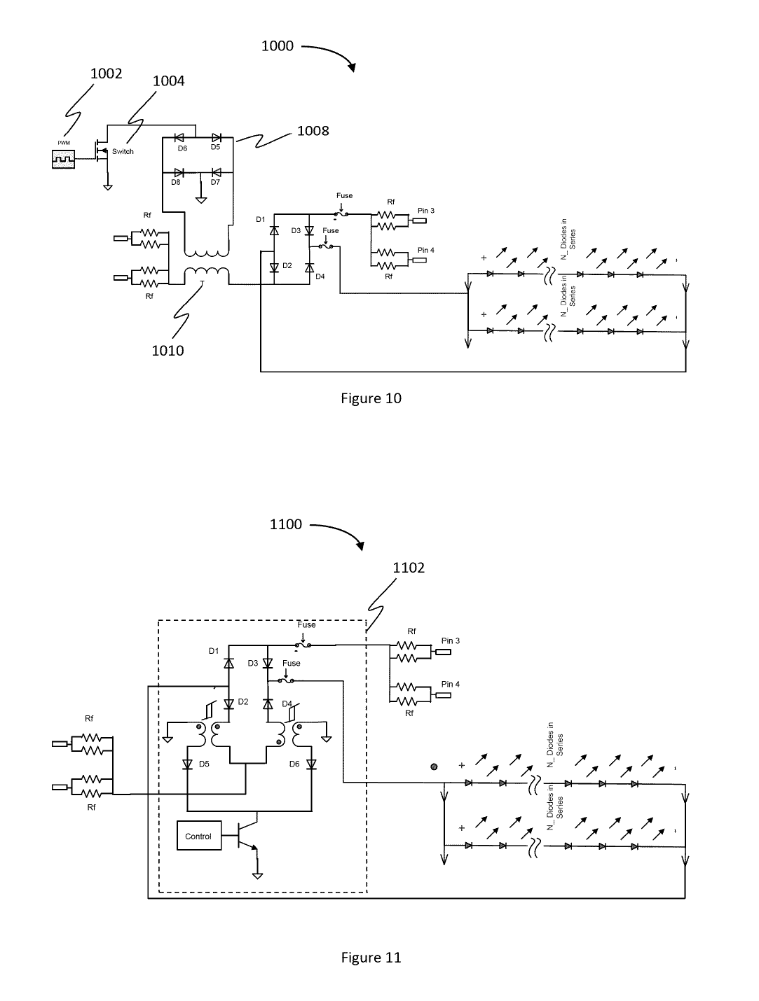

Referring now to FIG. 10, there is shown a schematic diagram of an LED lamp 1000 according to another embodiment of the invention. A dimming control is shown replacing elements 1 and 3, 602 and 606 respectively, that can adjust the intensity of the light coming from the one or more than one LED 502. A switch 1004, a transformer 1010 and full wave rectifier 1008 comprising diodes D5, D6, D7 and D8, and a pulse width modulator (PWM) 1002 that is connected to the switch 1004 can control the light level. Optionally, a power supply can be added to provide power for the control functions. Power from the ballast passes through the PWM 1002 that controls the amount of AC power provided to the switch 1004. As is understood, the PWM 1002 modulates the power levels to mimic a sine wave. This sinusoidal power is passed through the switch to the full wave rectifier 1008 where power ripples are reduced. The power is then transmitted to the transformer 1010 and sent to the one or more than one LED 502 to provide light. Optionally, the transformer 1010 can be either a step up or step down transformer depending upon the power requirements and the implemented design.

Referring now to FIG. 11, there is shown a schematic diagram of an LED lamp 1100 according to another embodiment of the invention. A magnetic amplifier 1102 is used to control the phase of the current wave form and the light level.

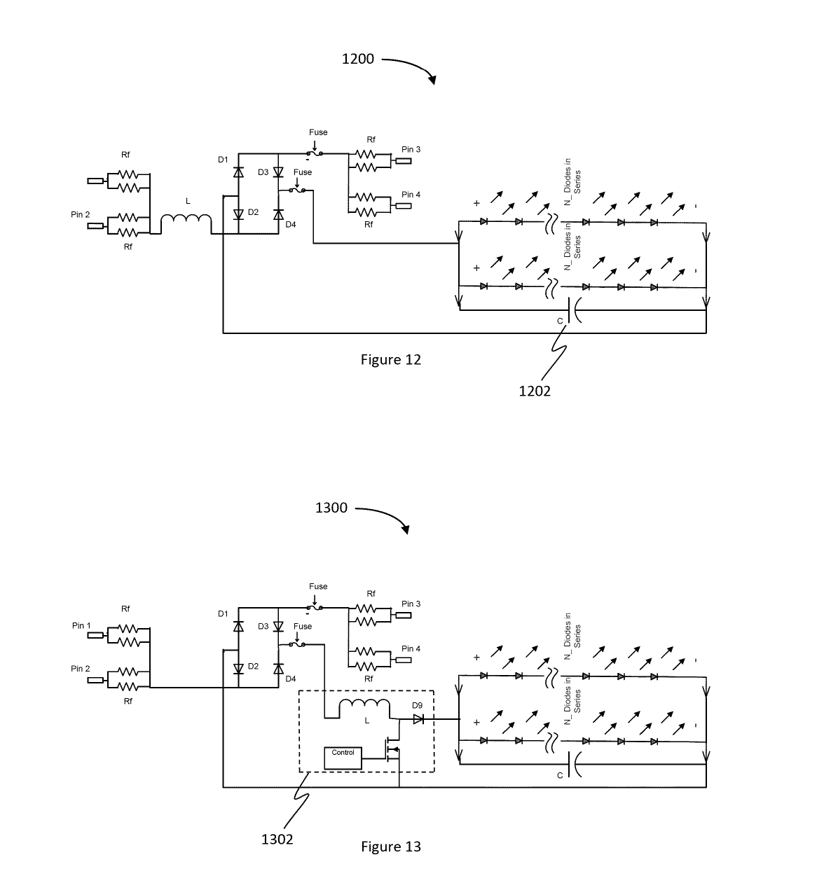

Referring now to FIG. 12, there is shown a schematic diagram of an LED lamp 120 according to another embodiment of the invention. As can be seen, a capacitor 1202 is added in parallel across the one or more than one LED 502 to increase the conduction angle of the one or more than one LED 502. As will be understood by those with skill in the art with reference to this disclosure, an inductor (not show) can also be used in place of the capacitor to increase the conduction angle of the one or more than one LED 502.

Referring now to FIG. 13, there is shown a schematic diagram of an LED lamp 1300 according to another embodiment of the invention. In this embodiment, a boost converter 1302 is used to add voltage when the wave form is below the breakdown of the one or more than one LED 504. The boost converter 1302 can also be used to power an 8 foot lamp on a ballast designed for 4 foot lamps. This would increase the voltage beyond what is available from the ballast.

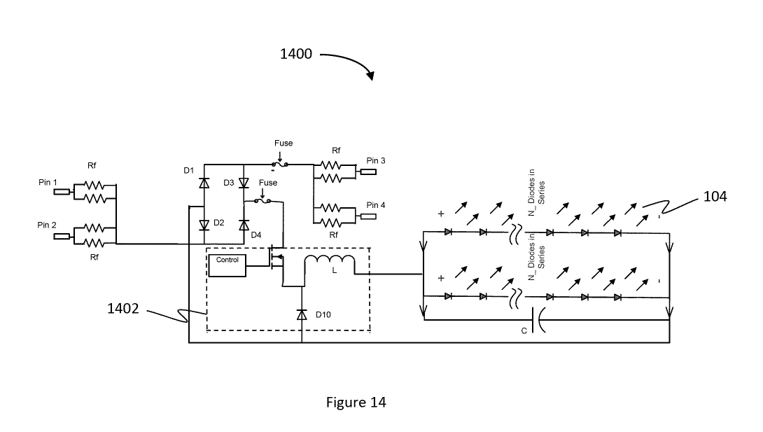

Referring now to FIG. 14, there is shown a schematic diagram of an LED lamp 1400 according to another embodiment of the invention. Here, a buck converter 1402 is used to control the light level by PWM of the switch. As is understood, the buck converter 1402 steps down the voltage and steps up the current applied to the one or more than one LED 502.

What has been described is a new and improved circuit for an LED lamp that looks identical to a fluorescent lamp with the pins to mate with the tombstones and utilize the ballast already in the fixture, overcoming the limitations and disadvantages inherent in the related art. Although the present invention has been described with a degree of particularity, it is understood that the present disclosure has been made by way of example and that other versions are possible. Various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. An LED lamp that looks identical to a fluorescent lamp that utilize the ballast already in a fluorescent lamp fixture, the LED lamp comprising:
a) a housing;
b) one or more than one LED attached to the housing;
c) pins connected to the housing to mate with the tombstones of a fluorescent lamp fixture; and
d) control circuitry to duplicate standard fluorescent lamp operations with existing AC ballast and emulate the filament winding resistance of a conventional fluorescent lamp.

2. The LED lamp of claim 1, where the housing is substantially similar to the housing of a typical fluorescent lamp.

3. The LED lamp of claim 1, where the one or more than one the LED is connected in series until the voltage drop equals that of a typical fluorescent lamp.

4. The LED lamp of claim 1, where the one or more than one the LED is connected in parallel to limit the current.

5. The LED lamp of claim 1, where the control circuitry comprises a plurality or rectifying diodes and a plurality of resistors to rectify the AC voltage from a ballast of the fluorescent lamp fixture.

6. The LED lamp of claim 1, where the plurality of resistors simulate the filament resistance of the conventional fluorescent lamp.

7. The LED lamp of claim 1, where the lamp housing further comprise one or more than one fuse for protection in the event of failed components.

8. The LED lamp of claim 1, where the pins at each end of the LED lamp are shorted together if the ballast in the fixture is in an instant start ballast.

9. The LED lamp of claim 1 further comprising one or more than one electrical element to provide additional control of the LED lamp.

10. The LED lamp of claim 9, where the one or more than one electrical element is in series with the one or more than one LED to increase the voltage of the lamp to equal that of the fluorescent lamp.

11. The LED lamp of claim 9, where the one or more than one electrical element is in parallel with the one or more than one LED to increase the current of the lamp.

12. The LED lamp of claim 9, where the one or more than one electrical element is a passive component.

13. The LED lamp of claim 9, where the passive component is a capacitor, an inductor or both a capacitor and an inductor.

14. The LED lamp of claim 13, where the capacitor and the inductor are 90 degrees out of phase with the voltage.

15. The LED lamp of claim 9, where the one or more than one electrical element is an active component.

16. The LED lamp of claim 15, where the one or more than one electrical element is a dimming control that can adjust the intensity of the light coming from the one or more than one LED.

17. The LED lamp of claim 16 further comprising a power supply to provide power for the control functions.

18. The LED lamp of claim 15, where the one or more than one electrical element is a magnetic amplifier to control the phase of the current wave form and the light level.

19. The LED lamp of claim 15, where the one or more than one electrical element is a capacitor in parallel across the one or more than one LED to increase the conduction angle of the one or more than one LED.

20. The LED lamp of claim 15, where the one or more than one electrical element is an inductor in parallel across the one or more than one LED to increase the conduction angle of the one or more than one LED.

21. The LED lamp of claim 15, where the one or more than one electrical element is a boost converter to add voltage when the wave form is below the breakdown of the one or more than one LED.

22. The LED lamp of claim 15, where the one or more than one electrical element is a buck converter to control the light level.
